(19) United States
(12) Patent Application Publication
(10) Pub. No.: US 2025/0258903 A1
(43) Pub. Date: Aug. 14, 2025

(54) Interaction of Physical Entities

(71) Applicant: Siemens Aktiengesellschaft, München (DE)

(72) Inventors: Aliza Maftun, München (DE); Wolfgang Klasen, Ottobrunn (DE); Rainer Falk, Erding (DE); Steffen Fries, Baldham (DE); Kai Fischer, Baldham (DE); Markus Heintel, München (DE)

(73) Assignee: Siemens Aktiengesellschaft, München (DE)

(21) Appl. No.: 18/849,358

(22) PCT Filed: Mar. 3, 2023
(86) PCT No.: PCT/EP2023/055411

§ 371 Date: Sep. 20, 2024

(30) Foreign Application Priority Data
Mar. 23, 2022 (EP) 22163888.5

(51) Int. Cl. G06F 21/44; G06F 9/455

(52) U.S. Cl. CPC G06F 21/44; G06F 9/45512

(57) ABSTRACT

Various embodiments include a method for controlling interaction between a first physical entity and a second physical entity. An example includes: receiving an interaction request from the second physical entity at the first physical entity; in response to the interaction request, transmitting a verification request to a first virtual entity representing the first physical entity; in response to the verification request, determining a measure of a trustworthiness of the second physical entity; and controlling interaction of the second physical entity with the first physical entity on the basis of the measure of the trustworthiness of the second physical entity.

### CROSS-REFERENCE TO RELATED APPLICATIONS

This application is a U.S. National Stage Application of International Application No. PCT/EP2023/055411 filed Mar. 3, 2023, which designates the United States of America, and claims priority to EP Application No. 22163888.5 filed Mar. 23, 2022, the contents of which are hereby incorporated by reference in their entirety.

### TECHNICAL FIELD

The present disclosure relates to interaction of a first physical entity with a second physical entity. Various embodiments of the teachings herein include systems and/or methods for managing or controlling such interactions.

### BACKGROUND

Central aspects in the context of so-called Industry 4.0, also referred to as I4.0, are the integration of cyber-physical systems, CPS, and devices of the so-called Internet of things, IoT. One aim is to provide, for example, dynamic, self-organizing and flexible cross-company value chains. The vision of I4.0 describes open digital ecosystems in which the physical assets are represented by their digital twins, DTs. The DTs provide information relating to the respective entities in a machine-readable and processable language and can sometimes, under certain circumstances, interact directly with one another. DTs are a widely researched and assumed method for accelerating digitization in the industrial environment.

The relationships of trust between entities were previously based, for example, on historical relationships or positive recommendations from a trusted authority. For rapid digitization and adaptation of Industry 4.0, it is desirable to provide reliable communication between various physical entities, for instance devices, machines or hardware and/or software components, on an ad hoc basis. Therefore, conventional methods for building trust in the I4.0 environment do not suffice for secure interaction between physical entities.

The publication “IIoT Value Chain Security—The Role of Trustworthiness” by the Federal Ministry for Economy and Climate Protection dated Sep. 23, 2020 proposes a data structure as a trustworthiness profile that makes it possible to systematically exchange the expectations of buyers and the corresponding capabilities of the potential suppliers in a supply chain. The basic idea of the trustworthiness profile is that the buyer lists his trustworthiness expectations and the supplier provides verifiable proof of his corresponding trustworthiness capabilities. On the basis of the received capabilities, the buyer can either negotiate his conditions of trust with the supplier or can determine the degree of trust in his future communication with this specific supplier.

### SUMMARY

Teachings of the present disclosure include systems and methods usable to ensure secure interaction between physical entities in an automated manner. As an example, some embodiments include a method for interaction of a first physical entity (1a) with a second physical entity (2a), wherein the first physical entity (1a) is used to receive an interaction request from the second physical entity (2a), characterized in that in response to the interaction request, the first physical entity (1a) is used to transmit a verification request to a first virtual entity (1b) which is a virtual representation of the first physical entity (1a); in response to the verification request, the first virtual entity (1b) is used to determine a measure of a trustworthiness of the second physical entity (2a); and interaction of the first physical entity (1a) with the second physical entity (2a) is allowed on the basis of the measure of the trustworthiness of the second physical entity (2a).

In some embodiments, the first virtual entity (1b) is in the form of a first administration shell.

In some embodiments, the first virtual entity (1b) is used to determine trustworthiness information (5) relating to at least one trustworthiness criterion of the second physical entity (2a) in response to the verification request; and to determine the measure of the trustworthiness of the second physical entity (2a) on the basis of the trustworthiness information (5).

In some embodiments, in response to the verification request, the first virtual entity (1b) is used to transmit a request to provide the trustworthiness information (5) to a second virtual entity (2b) which is a virtual representation of the second physical entity (2a); and in response to the request, the second virtual entity (2b) is used to transmit the trustworthiness information (5) to the first virtual entity (1b).

In some embodiments, the request to provide the trustworthiness information (5) comprises at least a definition and/or description (4) of the at least one trustworthiness criterion.

In some embodiments, the second virtual entity (2b) is in the form of an administration shell.

In some embodiments, the first virtual entity (1b) is used to receive a predefined rule (6) for assessing the trustworthiness of the second physical entity (2a); and to determine the measure of the trustworthiness of the second physical entity (2a) on the basis of the rule (6).

In some embodiments, the measure of the trustworthiness of the second physical entity (2a) is determined as a binary measure, and the interaction of the second physical entity (1a) with the first physical entity (2a) is allowed if the measure of the trustworthiness of the second physical entity (2a) corresponds to a first predefined value; and/or is not allowed if the measure of the trustworthiness of the second physical entity (2a) corresponds to a second predefined value.

In some embodiments, the measure of the trustworthiness of the second physical entity (2a) is determined by determining one of three or more trustworthiness levels for the second physical entity (2a).

In some embodiments, the interaction of the second physical entity (1a) with the first physical entity (2a) is allowed if the measure of the trustworthiness of the second physical entity (2a) corresponds to a first trustworthiness level of the three or more trustworthiness levels; and/or is allowed to a restricted extent if the measure of the trustworthiness of the second physical entity (2a) corresponds to a second trustworthiness level of the three or more trustworthiness levels; and/or is not allowed if the measure of the trustworthiness of the second physical entity (2a) corresponds to a third trustworthiness level of the three or more trustworthiness levels.

As another example, some embodiments include a system (7) having a first physical entity (1a) which is configured to receive an interaction request from a second physical entity (2a), characterized in that the system (7) has a first virtual entity (1b) which is a virtual representation of the first physical entity (1a); the first physical entity (1a) is configured, in response to the interaction request, to transmit a verification request to the first virtual entity (1b); the first virtual entity (1b) is configured, in response to the verification request, to determine a measure of a trustworthiness of the second physical entity (2a); and the first physical entity (1a) and/or the first virtual entity (1b) is/are configured to allow interaction of the first physical entity (1a) with the second physical entity (2a) on the basis of the measure of the trustworthiness of the second physical entity (2a).

In some embodiments, the system (7) contains the second physical entity (1a) and the latter is configured to transmit the interaction request to the first physical entity (1a).

In some embodiments, the first virtual entity (1b) is configured in response to the verification request, to determine trustworthiness information (5) relating to at least one trustworthiness criterion of the second physical entity (2a); and to determine the measure of the trustworthiness of the second physical entity (2a) on the basis of the trustworthiness information (5).

In some embodiments, the system (7) has a second virtual entity (2b) which is a virtual representation of the second physical entity (2a); the first virtual entity (1b) is configured, in response to the verification request, to transmit a request to provide the trustworthiness information (5) to the second virtual entity (2b); and the second virtual entity (2b) is configured, in response to the request, to transmit the trustworthiness information (5) to the first virtual entity (1b).

As another example, some embodiments include a computer program product having instructions, which, when executed by a system (7) as described herein, cause the system (7) to carry out one or more of the methods described herein.

### BRIEF DESCRIPTION OF THE DRAWINGS

The teachings of the present disclosure are explained in more detail below using specific embodiments and associated schematic drawings. In the figures, identical or functionally identical elements can be provided with same reference signs. The description of identical or functionally identical elements is possibly not necessarily repeated with regard to different figures. In the drawings:

FIG. 1 shows a schematic block diagram of an example system incorporating teachings of the present disclosure; and

FIG. 2 shows a schematic block diagram of a first virtual entity of an example system incorporating teachings of the present disclosure.

### DETAILED DESCRIPTION

Some examples of the teachings herein include a method for controlling the interaction of a first physical entity with a second physical entity. The first physical entity is used to receive an interaction request from the second physical. In response to the interaction request, the first physical entity is used to transmit a verification request to a first virtual entity, wherein the first virtual entity is a virtual representation of the first physical entity. In response to the verification request, the first virtual entity is used to determine a measure of trustworthiness of the second physical entity. Interaction of the first physical entity with the second physical entity is allowed on the basis of the measure of the trustworthiness of the second physical entity, for example by means of the first physical entity and/or the first virtual entity.

The second physical entity transmits, in particular, the interaction request to the first physical entity. The interaction request comprises, for example, information or a request to the effect that the second physical entity intends to interact with the first physical entity. Interaction may comprise an exchange of data and/or information and/or signals and/or instructions and may be carried out in a bidirectional or unidirectional manner.

A physical entity may be a device, for example. A device is distinguished here in the following text, for example, by the fact that it comprises at least one hardware component and optionally one or more software components. A hardware component as such is likewise a possibility for a physical entity. A software component as such may also be a physical entity. A software component is specifically implemented on a data carrier or a programmable component and can therefore likewise be interpreted as physical. In particular, the term “physical” is used here and below as a distinction from the term “virtual”.

The first physical entity may be, for example, a first device, for example an IoT device or an industrial control device. The second physical entity may be, for example, a second device which is communicatively connected to the first device via a data network. The second physical entity may be, for example, a second IoT device or a second industrial control device. It is likewise possible, for example, for the second physical entity to be a component of the first device. The component can be integrated in the first device permanently or exchangeably, for example as a plug-in card. The component may likewise be, for example, a plug-on module or expansion module connected to the first device.

A virtual entity is a virtual, in particular digital, representation of an associated physical entity. In particular, a virtual entity may include a digital twin, DT, of the corresponding physical entity. Accordingly, the first virtual entity is, for example, a digital twin of the first physical entity. For example, a second virtual entity may be a digital twin of the second physical entity.

A digital twin may be interpreted as a virtual representation of a real object, for example a device, a machine and so on, or of any other physical entity, for example a software component. In I4.0 terminology, this digital representation is also referred to as an administration shell, AAS (asset administration shell), for example. Digital twins may be implemented, in particular, on IT systems, in particular corresponding computing units, and may be addressed, for example, using an address, for instance an IP address (Internet Protocol), a DNS name (Domain Name System), a URL (Uniform Resource Locator) and so on.

In the context of supply chains for example, it is very advantageous if I4.0 devices, I4.0 components and I4.0 products have a common language in order to be able to communicate with one another in an automated manner. A standardized format such as AAS is therefore advantageous.

In some embodiments, the first virtual entity is in the form of a first administration shell, for example, and the second virtual entity is in the form of a second administration shell, in particular.

A physical entity, in particular the first and/or the second physical entity, may comprise, in particular, one or more computing units, which can also include one or more control units or the like, one or more communication interfaces, for example hardware and/or software interfaces, or the like. Method steps which are carried out by means of a physical entity may be carried out, in particular, by means of the at least one corresponding computing unit, for example with the involvement of the at least one communication interface.

A virtual entity, in particular the first and/or the second virtual entity, is only computer-implemented, for example, that is to say on one or more corresponding computing units of the respective virtual entity. However, one or more computing units may also implement a plurality of virtual entities. Method steps which are carried out by means of a virtual entity are carried out, in particular, by means of the corresponding one or more computing units implementing the respective virtual entity.

A physical entity and an associated virtual entity, that is to say in the present case, for instance, the first physical entity and the associated first virtual entity as well as the second physical entity and the associated second virtual entity, can communicate with one another via their respective computing units and possibly hardware and/or software interfaces and can accordingly exchange data and information.

The teachings herein include highly automated, in particular fully automated, possible ways of implementing secure interaction between the first and the second physical entity by virtue of the first physical entity verifying the trustworthiness of the second physical entity by means of the first virtual entity. In particular, they may ensure the trustworthiness between various I4.0 entities during their entire life cycle.

In some embodiments, in response to the verification request, trustworthiness information relating to at one least trustworthiness criterion, in particular a predefined trustworthiness criterion, of the second physical entity is determined, in particular at least partly using the first virtual entity. The measure of the trustworthiness of the second physical entity is determined on the basis of the trustworthiness information.

In some embodiments, in order to determine the trustworthiness information, in response to the verification request, the first virtual entity is used to transmit a request to provide the trustworthiness information to a second virtual entity, wherein the second virtual entity is a virtual representation of the second physical entity. In response to the request to provide the trustworthiness information, the second virtual entity is used to transmit the trustworthiness information to the first virtual entity.

In some embodiments, the request to provide the trustworthiness information comprises at least a definition and/or description of the at least one trustworthiness criterion.

The definition or description of the at least one trustworthiness criterion may describe or concern, for example, expectations of the first virtual or first physical entity in terms of the trustworthiness of the second physical entity. By virtue of the request to provide the information already comprising the definition and/or description of the at least one trustworthiness criterion, the trustworthiness information provided by the second virtual entity can be transmitted and provided in a manner specifically adapted to the definition and/or description. Processing and checking of the trustworthiness information by the first virtual entity can therefore be carried out with an extended computing effort and possibly within a shorter time. However, in principle, it is also possible for the request to provide the trustworthiness information to not comprise such a definition and/or description. The second virtual entity can then transmit all trustworthiness information that is possibly available.

In some embodiments, the first virtual entity is used to receive, in particular receive and store, a predefined rule for assessing the trustworthiness of the second physical entity. The measure of the trustworthiness of the second physical entity is determined on the basis of the rule. The rule may be stored, for example, by the first virtual entity before the interaction request.

In particular, the measure of the trustworthiness of the second physical entity is determined on the basis of the trustworthiness information and the predefined rule. For this purpose, the trustworthiness information, for example, is compared with the rules or aligned with the rules. The measure of the trustworthiness can then be defined or determined in two or more stages, for example.

In some embodiments, the measure of the trustworthiness of the second physical entity is determined, in particular on the basis of the rule and/or the trustworthiness information, as a binary measure. This may be understood as meaning, in particular, the fact that the measure of the trustworthiness can assume one of precisely two different values, for example 0 and 1, where one of the two different values corresponds to a situation in which there is trustworthiness and the other value corresponds to a situation in which there is no trustworthiness.

In some embodiments, the interaction of the second physical entity with the first physical entity is allowed, for example allowed precisely, if the measure of the trustworthiness of the second physical entity corresponds to a first predefined value.

In some embodiments, the interaction of the second physical entity with the first physical entity is not allowed, in particular is not allowed precisely, if the measure of the trustworthiness of the second physical entity corresponds to a second predefined value which differs from the first predefined value.

In some embodiments, the measure of the trustworthiness of the second physical entity is determined by determining, in particular on the basis of the rule and/or the trustworthiness information, one, in particular precisely one, of three or more trustworthiness levels for the second physical entity. In other words, the measure of the trustworthiness then corresponds to the determined trustworthiness level.

In some embodiments, the interaction of the second physical entity with the first physical entity is allowed, in particular is allowed precisely, for example is allowed to an unrestricted extent, if the measure of the trustworthiness of the second physical entity corresponds to a first predefined trustworthiness level of the three or more trustworthiness levels.

In some embodiments, the interaction of the second physical entity with the first physical entity is allowed to a restricted extent, in particular is allowed to a restricted extent precisely, if the measure of the trustworthiness of the second physical entity corresponds to a second predefined trust level of the three or more trustworthiness levels.

In some embodiments, the interaction of the second physical entity with the first physical entity is not allowed, in particular is not allowed precisely, if the measure of the trustworthiness of the second physical entity corresponds to a predefined third trustworthiness level of the three or more trustworthiness levels. Such embodiments in which three or more trustworthiness levels are accordingly possible and the interaction is accordingly allowed to an unrestricted extent, allowed to a restricted extent or not allowed have the advantage that interaction need not be completely excluded even with restricted trustworthiness. For example, only security-relevant interactions can then be prevented or the like.

Some embodiments include a system having a first physical entity. The first physical entity is configured to receive an interaction request from a second physical entity. The system has a first virtual entity which is a virtual representation of the first physical entity. The first physical entity is configured, in response to the interaction request, to transmit a verification request to the first virtual entity. The first virtual entity is configured, in response to the verification request, to determine a measure of a trustworthiness of the second physical entity. The first physical entity and/or the first virtual entity is/are configured to allow interaction of the first physical entity with the second physical entity on the basis of the measure of the trustworthiness of the second physical entity. The second physical entity may likewise be part of the system in various embodiments of the systems described herein.

In some embodiments, the system contains the second physical entity and the second physical entity is configured to transmit the interaction request to the first physical entity.

Further embodiments of the system follow directly from the various configurations of the methods described herein and vice versa. In particular, individual features and corresponding explanations regarding the various embodiments of the methods can be similarly applied to corresponding embodiments of the system. In particular, the system may be designed or programmed to carry out one or more of the methods described herein.

Some embodiments include a computer program having instructions. If the instructions are executed by a system, the instructions cause the system to carry out one or more of the methods described herein. Some embodiments include a computer-readable storage medium storing a computer program as described herein.

A computing unit can be understood as meaning, in particular, a data processing device which contains a processing circuit. The computing unit can therefore process, in particular, data for the purpose of carrying out computing operations. These possibly also include operations in order to carry out indexed access to a data structure, for example a look-up table, LUT. The computing unit may contain, in particular, one or more computers, one or more microcontrollers and/or one or more integrated circuits, for example one or more application-specific integrated circuits, ASIC, one or more field-programmable gate arrays, FPGA, and/or one or more systems on a chip, SoC. The computing unit may also contain one or more processors, for example one or more microprocessors, one or more central processing units, CPU, one or more graphics processing units, GPU, and/or one or more signal processors, in particular one or more digital signal processors, DSP. The computing unit may also comprise a physical or virtual group of computers or others of the units mentioned.

In some embodiments, the computing unit comprises one or more hardware and/or software interfaces and/or one or more memory units. A memory unit may be configured as a volatile data memory, for example as a dynamic random access memory, DRAM, or a static random access memory, SRAM, or as a non-volatile data memory, for example as a read-only memory, ROM, as a programmable read-only memory, PROM, as an erasable programmable read-only memory, EPROM, as an electrically erasable programmable read-only memory, EEPROM, as a flash memory or flash EEPROM, as a ferroelectric random access memory, FRAM, as a magnetoresistive random access memory, MRAM, or as a phase-change random access memory, PCRAM.

If reference is made, within the scope of the present disclosure, to the fact that a component of the system or of a physical or virtual entity of the system, in particular a computing unit of the system, is configured, formed, designed or the like to carry out or implement a specific function, to achieve a specific effect or to serve a specific purpose, this can be understood as meaning the fact that the component, beyond the basic or theoretical usability or suitability of the component for this function, effect or purpose, is specifically and actually able, by means of an appropriate adaptation, programming, physical configuration and so on, to carry out or implement the function, to achieve the effect or to serve the purpose.

Further features of the teachings herein emerge from the claims, the figures and the description of the figures. The features and combinations of features mentioned above in the description and the features and combinations of features mentioned below in the description of the figures and/or shown in the figures can be included in the invention not only in the respectively stated combination, but also in other combinations. In particular, embodiments and combinations of features which do not have all of the features of an originally formulated claim can also be included in the invention. In addition, embodiments and combinations of features which go beyond or differ from the combinations of features stated in the dependency references of the claims can be included in the invention.

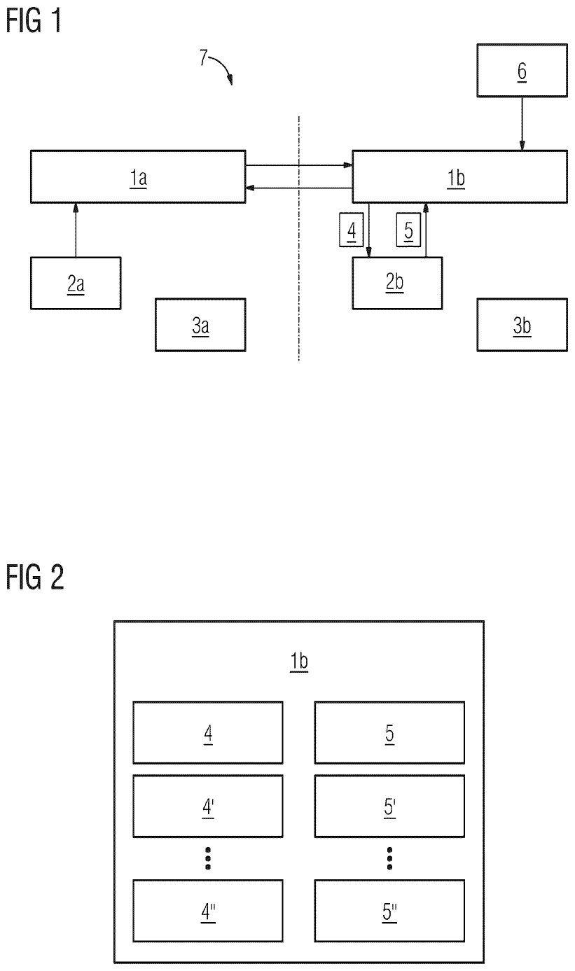

FIG. 1 schematically shows a block diagram of a system 7 incorporating teachings of the present disclosure. The system 7 has a first physical entity 1a and a second physical entity 2a. The system 7 has a first virtual entity 1b which is a digital twin of the first physical entity 1a, in particular an AAS of the first physical entity 1a. The system 7 also has a second virtual entity 2b which is a digital twin of the second physical entity 2a, in particular an AAS of the second physical entity 2a.

The system 7 optionally has a third physical entity 3a and a third virtual entity 3b which is a digital twin of the third physical entity 3a, in particular an AAS of the third physical entity 3a.

The second physical entity 2a may transmit an interaction request to the first physical entity 1a and, in response to this, the first physical entity 1a may transmit a verification request to its digital twin, that is to say to the first virtual entity 1b. In response to the verification request, the first virtual entity 1b may determine a measure of a trustworthiness of the second physical entity 2a, for example using the virtual entity 2b. On the basis of the measure of the trustworthiness of the second physical entity 2a, the first physical entity 1a and/or the first virtual entity 1b can allow or not allow or allow to a restricted extent the interaction of the first physical entity with the second physical entity, which was requested using the interaction request.

In this case, for example in response to the verification request, the first virtual entity 1b can request trustworthiness information 5 relating to at least one predefined trustworthiness criterion of the second physical entity 2a by virtue of the first virtual entity a request the transmitting to provide trustworthiness information 5 to the second virtual entity 2b. In some embodiments, the request to provide the trustworthiness information 5 from the first virtual entity 1b may comprise a definition and/or description 4 of the at least one trustworthiness criterion.

The first virtual entity 1b can then determine the measure of the trustworthiness on the basis of a predefined rule 6, in particular by comparing the predefined rule 6 with the trustworthiness information 5. The rule 6 may also be referred to as the guideline for a trust decision, for example.

The trustworthiness information 5 may comprise, for example, one or more qualification requirements or standardization requirements. For example, the trustworthiness information may comprise information as to whether a specific qualification or a specific test of the second physical entity was carried out according to a predefined standard, whether this test is currently still valid, how long it is still valid for, who carried out this test, for example whether an independent third party carried out the test, or the like.

Various embodiments of the invention propose a mechanism for dynamically exchanging and agreeing on relationships of trust between the various physical entities 1a, 2a which are each represented by a virtual entity 1b, 2b, namely their digital twin, and the interoperability of the exchanged trustworthiness information is guaranteed.

In some embodiments, the first physical entity 1a may be a device and the second entity 2a and the third entity 3a are components which may be part of the first physical entity 1a or may be separate from the latter. For example, a trustworthiness profile comprising the corresponding trustworthiness information 5 may be added to each of the associated virtual entities 1b, 2b, 3b. The respective trustworthiness profile may also comprise, for example, the respective trustworthiness expectations, for example given by the corresponding definitions and/or descriptions 4, along a supply chain.

The trustworthiness information 5 may be provided in any desired format, for example as text, XML, RDF or JSON. It may be digitally signed and/or encrypted using a cryptographic checksum. In one variant, the trustworthiness information 5 may be provided as a verifiable credential or as a verifiable presentation.

In some embodiments, the first physical entity 1a, for example the device, can check and ensure the trustworthiness of the second physical entity 2a, for example a component of the device or an external component, with which it is intended to interact or with which it interacts, on the basis of its own trustworthiness expectations.

On the basis of a defined trust decision policy, in particular given by the rule 6, the first physical entity 1a and/or the first virtual entity 1b compare(s) the trustworthiness information 5 received from the second virtual entity 2b and relating to the second physical entity 2a with its second virtual entity 2b and determines, on the basis thereof, whether the second physical entity 2a is trustworthy. On the basis of the comparison and the assessment, it is possible to draw a binary conclusion as to whether or not the component given by the second physical entity 2a is intended to be integrated, that is to say in particular accepted, in the device given by the first physical entity 1a.

In some embodiments, a behavior can be determined on the basis of the determined degree of trust, that is to say the determined measure of the trustworthiness. If the second physical entity 2a, for example, complies with only some of the trustworthiness expectations, the first virtual entity 1b can decide to partially trust the second physical entity 2a, and it is possible to activate, for example, a stringent device-internal security guideline which allows the component to only access necessary files. In the case of a non-trustworthy second physical entity 2a, a device-internal security guideline, which controls access to network functions, a file system and/or critical resources for example, can be changed to an enforcement mode.

The guideline for the trust decision can be predefined or flexible, with the result that additional dynamic conditions can also be taken into account. For example, specific production steps may require a higher degree of trust than other production steps.

The described example can also be extended to the effect that the second and/or third physical entity 2a, 3a check(s) the trustworthiness of the first physical entity 1a in a similar manner. This makes it possible, for example, for the second and/or third physical entity 2a, 3a to interact with the first physical entity 1a only when it is assumed that it is trustworthy. Interaction can also be accordingly restricted on the basis of the trust level.

The described example can furthermore also be extended to the effect that the second virtual entity 2b interacts with the second physical entity 2a in order to determine current trustworthiness information relating to the physical entity 2a or in order to check the up-to-dateness of the trustworthiness information available in the second virtual entity 2b before the second virtual entity 2b provides the trustworthiness information 5. The current trustworthiness information can be determined by the second virtual entity 2b, for example, repeatedly, periodically or after the description 4 has been transmitted. It is possible for the description 4 to comprise an indication of whether an up-to-dateness test should be carried out by the second virtual entity 2b before providing the trustworthiness information 5.

As soon as a physical entity has been accepted, the corresponding AAS can store, for example, the capabilities of the accepted physical entity by maintaining a list of all physical entities, or it can store only a link or an access path to the exchanged version of these capabilities. The first scenario is schematically illustrated in FIG. 2 using the example of the first virtual entity 1b which here stores the various trustworthiness expectations in the form of corresponding definitions and/or descriptions 4, 4′, 4″ as well as the associated trustworthiness information 5, 5′, 5″ received.

In addition, the trustworthiness information relating to the first physical entity 1a, that is to say the device for instance, can be adapted or updated on the basis of the trustworthiness information relating to the accepted physical entities 2a, 3a, that is to say, for instance, a second device or a third device or components of the device itself.

The digital twins may therefore administer the trustworthiness profile of their corresponding physical entities and can verify the trustworthiness of peer entities. The exchange of data or data communication between the physical entities can be allowed, refused or restricted on the basis of the check of the trustworthiness between the corresponding digital twins. The structure of the trustworthiness profile of a component may be included in the data relating to the corresponding digital twin, which may be in the form of a respective AAS, for example. In some embodiments, the respective AAS may contain a reference to the structure of the trustworthiness profile. The reference may be a URL, a URI (Uniform Resource Identifier), a cryptographic hash value or a reference to a transaction of a distributed database, in particular a transaction of a so-called distributed ledger or a blockchain infrastructure.

The physical entities and their corresponding digital twins may be identified or authenticated using technical means that are known per se, for example by means of a serial number or a digital device and/or machine certificate. In one variant, it is possible to use decentralized distributed identifiers which can be administered using a distributed ledger in the sense of a blockchain. An assertion confirmed by a verifiable credential or by a verifiable presentation can be used to reliably connect the identity of a physical entity to the identity of the corresponding digital twin.

For the purpose of explanation, the example of a device and its components was used, inter alia. However, the invention is not restricted thereto and can be used, in particular, for any desired I4.0 units with an associated digital twin, in particular AAS.

Various embodiments make it possible to establish trustworthiness between various I4.0 entities during their entire life cycle along a supply chain and/or even during operation. It not only makes it possible for the entities to determine the trustworthiness of the entities with which they interact, but also to update their own security guidelines and security measures on the basis of the capabilities of the interacting entities.

The interaction may be any type of interaction, for example the so-called onboarding of an entity, machine-to-machine communication and so on. Various machines of an industrial site may also request capabilities or determine the trustworthiness of another machine and may then decide what information they can share with it. Interoperability and the simple integration of various I4.0 units are therefore supported in a trustworthy manner.

What is claimed is:

1. A method for controlling interaction between a first physical entity and a second physical entity, the method comprising:
receiving an interaction request from the second physical entity at the first physical entity;
in response to the interaction request, transmitting a verification request to a first virtual entity representing the first physical entity;
in response to the verification request, determining a measure of a trustworthiness of the second physical entity; and
controlling interaction of the second physical entity with the first physical entity on the basis of the measure of the trustworthiness of the second physical entity.

2. The method as claimed in claim 1, wherein the first virtual entity comprises a first administration shell.

3. The method as claimed in claim 1, wherein the first virtual entity determines:
trustworthiness information relating to a trustworthiness criterion of the second physical entity in response to the verification request; and
the measure of the trustworthiness of the second physical entity using the trustworthiness information.

4. The method as claimed in claim 3, wherein:
in response to the verification request, the first virtual entity transmits a request for the trustworthiness information to a second virtual entity representing the second physical entity; and
in response to the request, the second virtual entity transmits the trustworthiness information to the first virtual entity.

5. The method as claimed in claim 4, wherein the request to provide the trustworthiness information comprises a definition of the trustworthiness criterion.

6. The method as claimed in claim 4, wherein the second virtual entity comprises an administration shell.

7. The method as claimed in claim 1, wherein the first virtual entity:
receives a predefined rule for assessing the trustworthiness of the second physical entity; and
determines the measure of the trustworthiness of the second physical entity based on the rule.

8. The method as claimed in claim 1, wherein:
the measure of the trustworthiness of the second physical entity is determined as a binary measure; and
the interaction of the second physical entity with the first physical entity:
is allowed if the measure of the trustworthiness of the second physical entity corresponds to a first predefined value; and/or
is not allowed if the measure of the trustworthiness of the second physical entity corresponds to a second predefined value.

9. The method as claimed in claim 1, wherein the measure of the trustworthiness of the second physical entity is determined by determining one of three or more trustworthiness levels for the second physical entity.

10. The method as claimed in claim 9, wherein the interaction of the second physical entity with the first physical entity:
is allowed if the measure of the trustworthiness of the second physical entity corresponds to a first trustworthiness level of the three or more trustworthiness levels; and/or
is allowed to a restricted extent if the measure of the trustworthiness of the second physical entity corresponds to a second trustworthiness level of the three or more trustworthiness levels; and/or
is not allowed if the measure of the trustworthiness of the second physical entity corresponds to a third trustworthiness level of the three or more trustworthiness levels.

11. A system comprising:
a first physical entity to receive an interaction request from a second physical entity;
a first virtual entity representing the first physical entity;
wherein the first physical entity is configured, in response to the interaction request, to transmit a verification request to the first virtual entity;
the first virtual entity is configured, in response to the verification request, to determine a measure of a trustworthiness of the second physical entity; and
the second physical entity is allowed to interact with the first physical entity on the basis of the measure of the trustworthiness of the second physical entity.

12. The system as claimed in claim 11, further comprising the second physical entity.

13. The system as claimed in claim 11, wherein the first virtual entity is configured:
in response to the verification request, to determine trustworthiness information relating to a trustworthiness criterion of the second physical entity; and
to determine the measure of the trustworthiness of the second physical entity on the basis of the trustworthiness information.

14. The system as claimed in claim 13, further comprising
a second virtual entity representing the second physical entity (2a);
wherein the first virtual entity is configured, in response to the verification request, to transmit a request to provide the trustworthiness information to the second virtual entity; and
the second virtual entity is configured, in response to the request, to transmit the trustworthiness information to the first virtual entity.

15. (canceled)
